(19) United States
(12) Patent Application Publication
(10) Pub. No.: US 2025/0376029 A1
(43) Pub. Date: Dec. 11, 2025

(54) SYSTEM FOR PREMOUNTING A DEVICE ON A STRUCTURAL ELEMENT OF A MOTOR VEHICLE

(71) Applicant: VALEO COMFORT AND DRIVING ASSISTANCE, Créteil (FR)

(72) Inventors: Nicolas Lepine, Créteil (FR); Willy Lachambre, Créteil (FR); Sylvain Treuillet, Créteil (FR); Christophe Bernier, Créteil (FR); Philippe Ducruet, Créteil (FR)

(73) Assignee: VALEO COMFORT AND DRIVING ASSISTANCE, Créteil (FR)

(21) Appl. No.: 18/877,271

(22) PCT Filed: Jun. 21, 2023
(86) PCT No.: PCT/EP2023/066883

§ 371 Date: Dec. 20, 2024

(30) Foreign Application Priority Data
Jun. 22, 2022 (FR) FR2206186

(51) Int. Cl. B60K 35/50; B60K 35/231

(52) U.S. Cl. CPC B60K 35/50; B60K 35/231; B60K 2360/84

(57) ABSTRACT

A pre-mounting system designed to facilitate the securing of a device on a structural element of a motor vehicle. The device includes a frame part which has at least one opening and a securing screw engaged through the opening. The pre-mounting system includes a securing means designed to be secured on said frame part; and a retention means designed to retain the securing screw along a main axis, and in a pre-mounting position through the opening. The pre-mounting system may also include a resiliently deformable part designed to retain the retention means in a position which is spaced from the frame part along the main axis, and is designed to be compressed automatically in order to bring the retention means into a position closer to the frame part along the main axis, to assist screwing of the securing screw on the structural element.

### TECHNICAL FIELD OF THE INVENTION

The present invention concerns in general securing of devices in motor vehicles.

More particularly, it concerns a pre-mounting system which is designed to facilitate the securing of a device on a structural element of a motor vehicle.

The invention has a particularly advantageous application in securing a heads-up display on the dashboard of a motor vehicle.

It also concerns a heads-up display equipped with a pre-mounting system of this type.

### PRIOR ART

In order to facilitate the driving of a motor vehicle and make it safer, it is desirable to avoid the driver being forced to look away from the road he is traveling along when he wishes to look at the dashboard, for example to see the speed at which he is traveling, or the direction he must take to reach his destination.

For this purpose, it is known to use a heads-up display, which is designed to display or project information (speed of the vehicle, direction to take, etc.) at the height of the gaze of the driver when he is observing the road.

A display of this type comprises a display screen which is conventional, but is positioned close to the windshield, or an image-formation device coupled to an image-return system which makes it possible to reflect the light beam emitted by the image-formation device towards a partly reflective plate (also known as a “combiner”) which is situated in the field of vision of the driver (or directly to the windshield).

In all cases, a display of this type comprises a frame which is designed to be added into the passenger compartment of the vehicle, more specifically on or in the dashboard of the vehicle, i.e. below the windshield.

Taking into account this position which is difficult to access, it will be understood that the mounting of the frame in the dashboard can be complicated.

A heads-up display is thus known from document DE102018114903 which comprises a frame equipped with two wings each having two openings for the passage of securing screws. Below each of its openings, each wing comprises a pre-mounting system. Each pre-mounting system comprises a clipping means in order to be secured below the wing, and a screwing well which is placed below the opening. This screwing well makes it possible to pre-screw the securing screw, in order to maintain it in a high position (not yet screwed into the dashboard).

This pre-mounting system thus makes it possible to retain the securing screws in positions such that, once the display has been correctly adjusted relative to the dashboard, these screws are well-centered and retained above tapped bores provided in the dashboard. The screwing operation is thus facilitated, since it does not require the screws to be positioned and held in the hand while they are being screwed.

It is understood that the screws can be retained only if the height of the well is sufficient for the thread of the screw to engage in it along a satisfactory length.

The major disadvantage of this pre-mounting system is therefore that it has a significant size in terms of height.

In practice, it thus protrudes below the support plane for the wings on the vehicle dashboard, which complicates the putting into place of the heads-up display on this dashboard.

### PRESENTATION OF THE INVENTION

In order to eliminate the aforementioned disadvantage of the prior art, the present invention proposes a pre-mounting system which is less inconvenient.

More particularly, according to the invention, a pre-mounting system is proposed which is designed to facilitate the securing of a device (typically the heads-up display) on a structural element of a motor vehicle (typically the dashboard), this device comprising a frame part which has at least one opening and a securing screw engaged through said opening.

According to the invention, the pre-mounting system comprises:
a securing means which is designed to be secured on said frame part;
a retention means which is designed to retain the securing screw along a main axis, and in a pre-mounting position through the opening; and
a deformable part which, at rest, is designed to retain the retention means in a position which is spaced from the frame part (and thus from the securing means) along the main axis, and is designed to be compressed in order to bring the retention means into a position closer to the frame part (and thus the securing means) along the main axis, to assist screwing of the securing screw on the structural element.

Thus, thanks to the invention, the pre-mounting system is raised relative to the frame part, as long as the securing screw is not screwed into the structural element of the motor vehicle.

Consequently, the assembly takes up less space below the frame part. In this case, the pre-mounting system need then not protrudes below this frame part. Thus, it does not impede this frame part being put into place on the structural element of the motor vehicle. In particular, it is thus possible to slide the frame part onto the structural element, which facilitates its putting into place relative to the structural element.

Other advantageous and non-limiting characteristics of the pre-mounting system according to the invention, taken individually or according to all the combinations technically possible, are as follows:
the retention means comprises a well through which the securing screw is designed to be screwed;
an end of the well is bordered, on part of its contour at least, by a support wall, from the edge of which said at least one deformable part extends;
the well is bordered around all of its contour by the support wall;
the deformable part is resiliently deformable;
the deformable part comprises at least two arms, which each comprise a first end secured on the support wall, and a free end situated at a height different from the first end, along the main axis, on the side of the well relative to the support wall;
each arm extends substantially radially relative to the main axis;
each arm extends substantially ortho-radially relative to the main axis;
the well has an inner face protruding from which there extend at least three ribs in which a thread of the securing screw is designed to engage;
blocking means are provided which are designed to block the well in rotation relative to the frame part;
the blocking means comprise at least one rib which extends protruding from an outer face of the well and/or from a face of the support wall;
the securing means and the retention means are rendered integral with one another by a resiliently deformable connection lug which is preferably curved on a plane orthogonal to the main axis;
the blocking means comprise at least one support stop against which the resiliently deformable connection lug is designed to abut during the screwing of the securing screw;
the securing means is designed to clip into an opening provided in said frame part;
two means are provided for retention of two securing screws, which are rendered integral with one another such as to be movable relative to one another on a plane orthogonal to the main axis.

The invention also proposes a display for a motor vehicle, comprising a frame part which has at least one opening, a securing screw engaged through the opening, and a pre-mounting system as previously described, the securing means of which is secured on said frame part.

Preferably, the frame part comprises engagement means which are designed to engage in complementary receiving means of the structural element of the motor vehicle, by means of a sliding movement.

It will be appreciated that the different characteristics, variants and embodiments of the invention can be associated with one another according to various combinations, provided that they are not incompatible or mutually exclusive.

### DETAILED DESCRIPTION OF THE INVENTION

The following description with reference to the appended drawings, which are given by way of non-limiting examples, will give a good understanding of what constitutes the invention and how it can be implemented.

In the appended drawings:

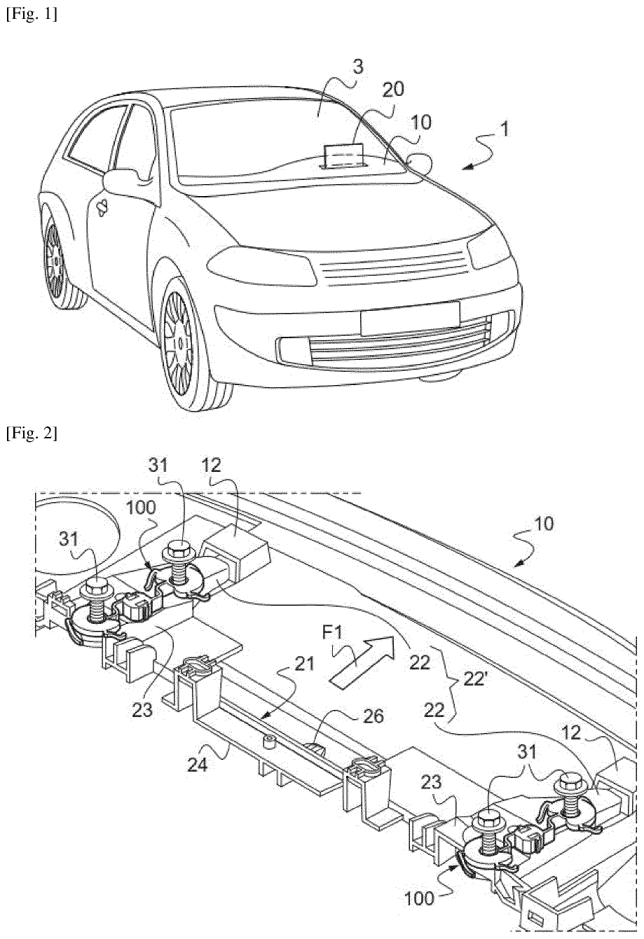

FIG. 1 is a schematic view in perspective of a motor vehicle equipped with a heads-up display according to the invention;

FIG. 2 is a schematic view of part of the dashboard of the motor vehicle of FIG. 1, above which there is added a frame part of the heads-up display equipped with two pre-mounting systems according to the invention;

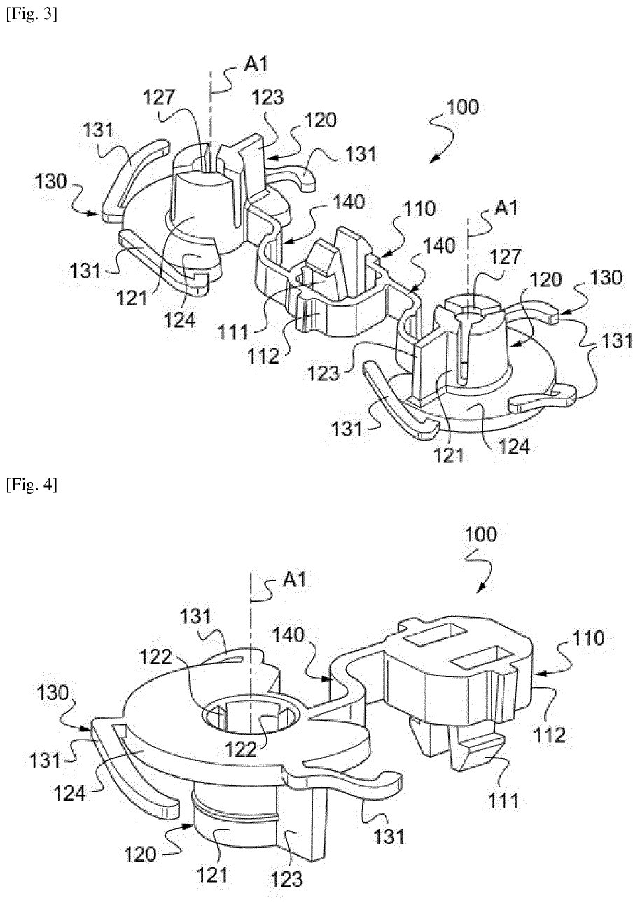

FIG. 3 is a schematic view in perspective of the pre-mounting system of FIG. 2, seen from a first angle;

FIG. 4 is a schematic view in perspective of a variant embodiment of the pre-mounting system of FIG. 3, seen from a second angle;

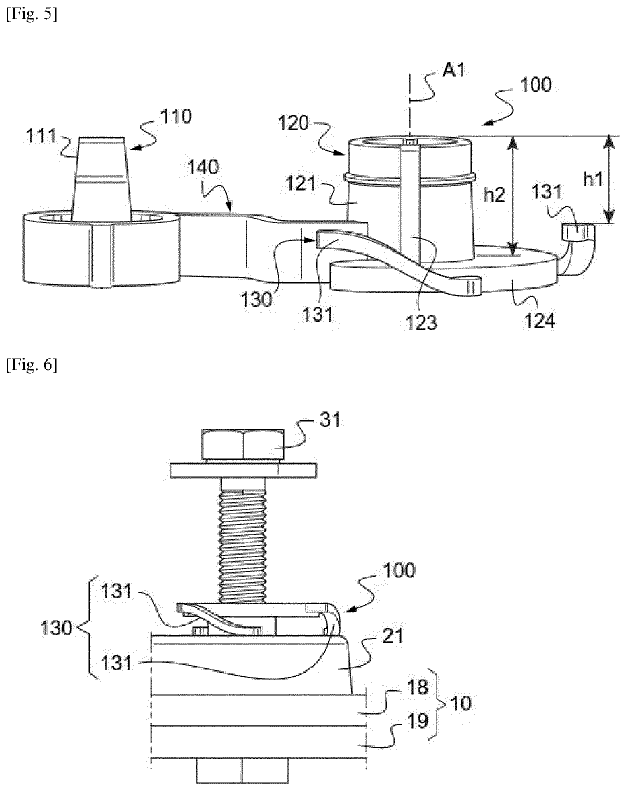

FIG. 5 is a schematic plan view of the pre-mounting system of FIG. 4;

FIG. 6 is a schematic plan view of the pre-mounting system of FIG. 4, of the heads-up display of FIG. 1, and of the dashboard of FIG. 2;

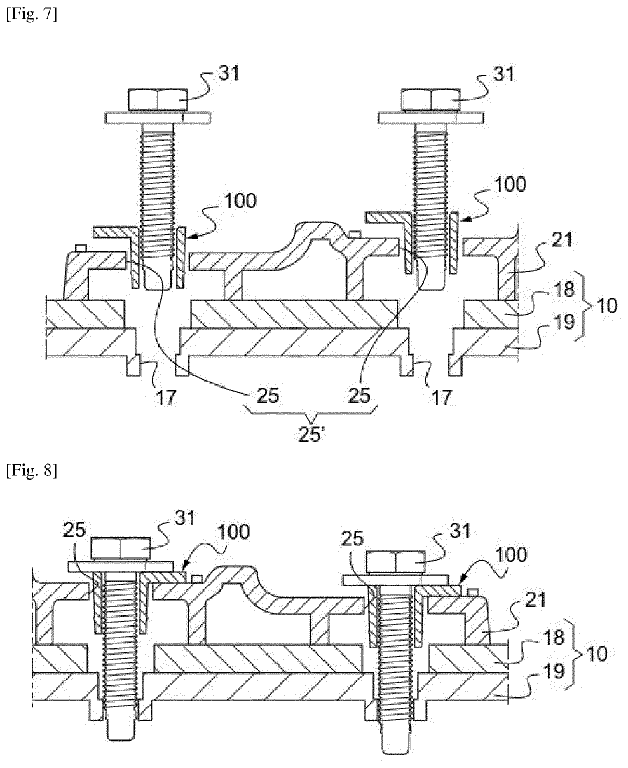

FIG. 7 is a schematic view in cross-section of two pre-mounting systems of the type represented in FIG. 4, illustrated in the position of rest, also showing a part of the heads-up display of FIG. 1 and the dashboard of FIG. 2;

FIG. 8 is a view similar to FIG. 7, in which the pre-mounting systems are illustrated in the position of use;

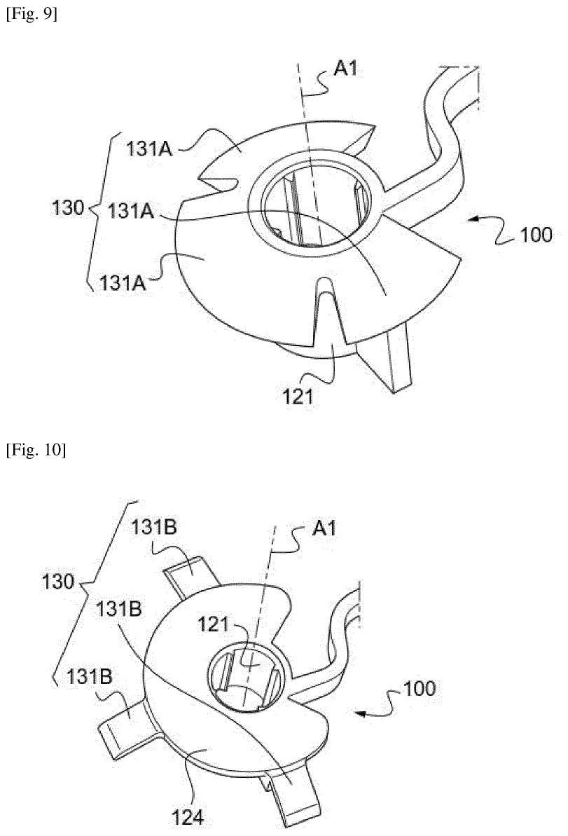

FIG. 9 is a schematic view in perspective of part of a pre-mounting system according to a second variant embodiment of the invention;

FIG. 10 is a schematic view in perspective of part of a pre-mounting system according to a third variant embodiment of the invention;

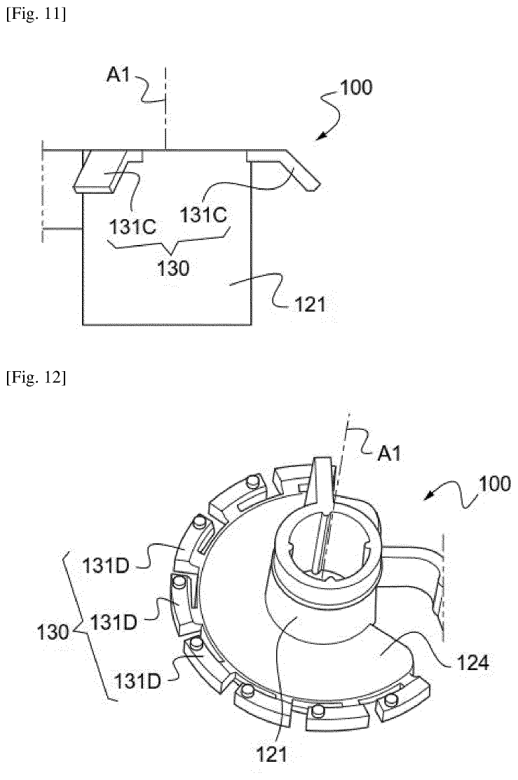

FIG. 11 is a schematic view in perspective of part of a pre-mounting system according to a fourth variant embodiment of the invention;

FIG. 12 is a schematic view in perspective of a part of a pre-mounting system according to a fifth variant embodiment of the invention;

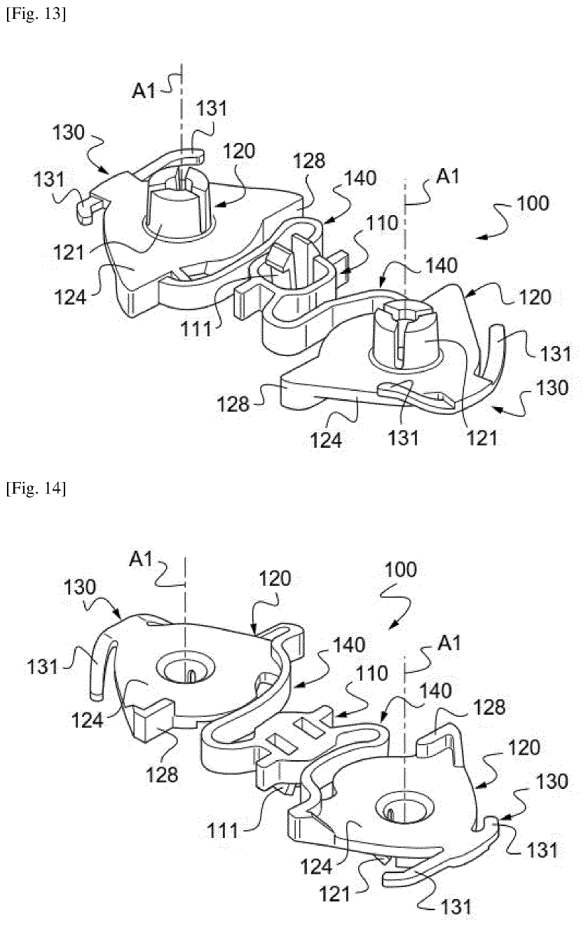

FIG. 13 is a schematic view in perspective of a pre-mounting system according to a sixth variant embodiment of the invention, represented from a first angle;

FIG. 14 is a schematic view in perspective of the pre-mounting system of FIG. 13, represented from a second angle.

Preliminarily, it will be noted that elements which are identical or similar of the different variant embodiments of the invention represented in the different figures will have the same reference numerals as far as possible, and will not be described each time.

FIG. 1 represents a motor vehicle 1. It can be any vehicle (automobile, motor bus, truck, etc.), but the invention preferably applies to automobiles.

This motor vehicle 1 conventionally comprises a chassis and a bodywork which delimit a passenger compartment for the driver and for the passengers of the vehicle.

This passenger compartment is closed at the front by a windshield 3 through which the driver can observe the road. It also accommodates different elements, including seats and a dashboard 10 situated at the front of the passenger compartment, below the windshield 3.

In practice, as shown by FIG. 7 in cross-section, in this case this dashboard 10 comprises a machine-welded metal structure 19, covered at the top by a part made of plastic, in this case a ventilator duct 18.

This motor vehicle 1 also comprises any device to be screwed into an area which is inconvenient to access.

In the example illustrated in the figures, and preferably, it is a heads-up display 20 to be screwed to the top of the dashboard 10, in the vicinity of the windshield 3 (see FIG. 1).

Hereinafter in the description, the terms “lower” (or “low”) and “upper” (or “high”) will be used relative to this motor vehicle, with the lower side of an element designating the part of this element which faces the floor side of the vehicle, and the upper side designating the part of this element which faces the opposite side.

As shown by FIG. 1, the heads-up display 20 is in this case designed to be fitted in the dashboard 10 such as to emerge therefrom in the vicinity of the windshield 3.

This heads-up display 20 could have different forms.

Thus, it could comprise one or more display screens (typically LCDs) designed to display images in the field of vision of the driver when the driver is looking at the road. This display is thus distinguished from the other screens of the vehicle in that it is situated above the upper face of the dashboard.

As a variant, the heads-up display 20 could comprise an image-formation device (for example an LCD screen) situated below the upper surface of the dashboard, and an image-return system (for example a set of mirrors), making it possible to return the images to the field of vision of the driver when he is looking at the road, above the dashboard.

In all cases, this heads-up display 20 comprises a frame which allows it to be secured on the dashboard (in this case on the machine-welded metal structure, above the ventilator duct 18).

In the example considered here, the frame of the heads-up display 20 comprises a particular part (hereinafter known as the “frame part 21”), which is illustrated in FIG. 2, and is specifically designed to permit the securing of the frame on the dashboard 10 of the motor vehicle 1.

This frame part 21 in this case has the form of a “U”, with two arms 23 connected by a base 24. It will be appreciated that it could have a different form.

In this case, it is made of a magnesium alloy, which provides it with good mechanical properties for a very limited weight, and which facilitates its production.

This frame part 21 comprises means for fitting 22′ and centering 26 on the dashboard 10, and means 25′ for screwing on this dashboard.

As shown by FIG. 2, the centering means 26 are used to facilitate putting the frame part 21 into place on the dashboard 10, so that the screwing means are correctly positioned relative thereto. For example, they are in the form of a split lug which is designed to cooperate with a stud of the dashboard 10 (not shown) by mounting it.

The fitting means 22′ for their part comprise, at the free ends of the arms 23, teeth 22 which are designed to engage in receptacles 12 formed in correspondence by the dashboard 10.

The centering 26 and fitting 22′ means thus make it possible to carry out pre-blocking of the frame part 21 on the dashboard 10.

The screwing means 25′ for their part ensure robust securing of these two elements. For this purpose, in each arm 23, they comprise at least one opening for passage of a securing screw 31. In the embodiment illustrated in this figure, each arm comprises more specifically two passage openings 25, each receiving a screw 31 (see FIG. 7).

The assembly of the frame part 21 with the dashboard 10 consists of sliding the frame part 21 on the dashboard 10, in a direction of sliding illustrated by the arrow F1, then of bolting the frame part 21 on the dashboard 10. As shown in cross-section by FIG. 7, the machine-welded structure 19 of the dashboard 10 comprises for this purpose four tapped bores 17 or four welded bolts. As a variant, the screws could be self-tapping in order to be able to be screwed into simple bores provided in the machine-welded structure 19.

In order for the sliding operation to take place without problems, the upper face of the dashboard 10 has two substantially flat portions on which the two arms 23 of the frame part 21 can slide. In correspondence, the lower face of each arm 23 must be without a relief forming an obstacle to the sliding.

Taking into account the reduced space between the dashboard 10 and the windshield 3 of the motor vehicle 1, it is also preferable for the screws 31 to be pre-mounted on the frame part 21, before this part is added onto the dashboard 10. By this means, the screwing operation will be facilitated.

Finally, it is also preferable to prevent the screws 31 from coming into contact with the frame part 21. In fact, since the screws 31 are made of steel, there would be a risk of galvanic corrosion if the screws touched the frame part 21 made of magnesium alloy.

It is in order to fulfil these three objectives that the frame part 21 is equipped with systems 100 for pre-mounting of the screws 31.

In FIG. 2, a pre-mounting system 100 is provided in each arm 23. Thus, each pre-mounting system 100 is in this case designed to receive two screws 31.

FIG. 3 represents in a view from below an embodiment of this pre-mounting system 100.

FIG. 4 to FIG. 8 represent a variant of this pre-mounting system 100 in which this system is designed to receive a single screw 31.

The following figures represent other variant embodiments of the pre-mounting system 100.

In all cases, this pre-mounting system 100 is formed by at least two parts, i.e.:
a securing means 110 which is designed to be secured on said frame part 21; and
one or two retention means 120 which is/are designed to retain a securing screw 31 along a main axis A1, and in a position of pre-mounting through the opening 25.

In this case, the securing means 110 comprises a snapping-on unit 111, which is designed to be clipped into an opening (not shown in the figures) provided in the frame part 21.

The retention means 120 for its part comprises a well 121 through which the screw 31 is designed to be screwed. This well 121 is preferably bordered, on its upper end side, by a support wall, which in this case is in the form of a collar 124 designed to be supported against the upper face of the frame part 21, around the opening for passage of the screw 31.

In this case, the well 121 and its collar 124 form an interface which prevent the screw 31 from coming into contact with the frame part 21.

The snapping-on unit 111 and the well 121 could have positions which are fixed relative to one another.

However, it happens that once the snapping-on unit 111 is clipped into the opening provided in the frame part 21, and once this part is centered on the dashboard 10, the well 121 may not be exactly on the axis of the tapped bore 17 designed to receive the screw 31. Consequently, preferably, the snapping-on unit 111 and the well 121 are connected by a resiliently deformable connection lug 140 which makes it possible to allow the well 121 sufficient freedom in order for the screw 31 to be able to be screwed into the tapped bore of the dashboard 10. The gap which is provided by this resiliently deformable connection lug 140 is preferably 1.7 mm in both directions of the space (in this case on the plane of the collar 124).

The resiliently deformable connection lug 140 is thus formed such that the snapping-on unit 111 and the well 121 are movable relative to one another on a plane orthogonal to the main axis A1. In this case, it is also formed such that the snapping-on unit 111 and the well 121 are movable relative to one another on the main axis A1, with a gap of approximately 2.5 mm.

According to the invention, the pre-mounting system 100 thus also comprises a resiliently deformable part 130 which is designed to retain the collar 124 in a position spaced from the frame part 21 along the main axis A1, and to be compressed automatically in order to bring the collar 124 into contact with the frame part 21, to assist the screwing of the securing screw 31 on the structural element 10.

The well 121, the collar 124, the resiliently deformable connection lug 140, the snapping-on unit 111 and the resiliently deformable part 130 could have different forms.

In the embodiment illustrated in FIG. 3, the well 121 has a cylindrical form of revolution around the main axis A1.

It has a cylindrical outer face which is designed to be engaged in the opening 25 provided in correspondence in the frame part 21. More specifically, in this case, it has an outer diameter slightly smaller than that of this opening (in this case the difference being 3.4 mm). By this means, thanks to the flexibility of the resiliently deformable connection lug 140, the position of the well can be adjusted such as to extend on the axis of the tapped bore 17 of the dashboard 10.

The well 121 is open at the bottom and at the top in order to allow the screw 31 to pass through it.

It has an inner cylindrical face of revolution, the cross-section of which is selected such that the thread of the screw 31 does not catch on to it.

In the embodiment of FIG. 3, in order to retain the screw 31 in the pre-mounting position, the low end of this well 121 is partly closed by a wall which is pierced in its center by an orifice 127. In correspondence, as shown for example by FIG. 7, the screw 31 has an end (opposite its head) which is smooth and without a thread, and is designed to be accommodated in the orifice 127 in order to retain the screw 31 there.

In order to allow the screw 31 to pass through the well 121 when it is being screwed, along most of its height this well 121 has three slots parallel to the main axis A1, which are regularly distributed around this axis, and open downwards. These slots thus delimit between one another three well parts, which are therefore designed to be spaced resiliently from the main axis A1 when the screw is screwed into the well 121.

FIG. 4 shows a variant embodiment of the pre-mounting system 100 of FIG. 3, which is distinguished in particular therefrom in that the well 121 is without a slot and a wall pierced by an orifice. In this variant, the well 121 is completely open at the top and the bottom, and has a cylindrical interior face, protruding from which there extend at least three ribs 122, in which the thread of the screw 31 is designed to engage. In other words, the thread of the screw 31 is designed to catch on the ribs 122 only, without engaging in the interior face of the well 121 (which reduces the screwing torque necessary to put the screw 31 into place). The length of these ribs 122 extends parallel to the main axis A1, and they have transverse cross-sections (on a plane orthogonal to the main axis A1) which are uniform and have triangular forms, with tops facing towards this axis.

As shown by FIG. 3 or FIG. 4, the collar 124 which borders the upper end of the well 121 in this case extends over more than half of the contour of the well, in order to form a good support for the head of the screw 31. It is however interrupted, such that the resiliently deformable connection lug 140 can catch on the well 121.

As a variant, and preferably, as shown by FIG. 13 and FIG. 14, the collar 124 can extend all around the well 121, such that the head of the screw 31 can be supported on it uniformly (which makes it possible to distribute the stresses well).

This collar 124 has flat upper and lower faces. As shown for example by FIG. 6, the lower face of the collar is designed to be supported against the upper face of the frame part 121, whereas the upper face of the collar 124 is designed to receive the screw 31 head.

As shown by FIG. 5, the height h2 of the well 121, measured from the lower face of the collar 124, is selected such that, once the screw has been pre-screwed in this well, it remains well retained in position, along the main axis A1. In particular, it must be able to withstand substantial forces, of the type exerted by a screw-driving machine.

In this case, this height h2 is greater than the thickness of the frame part 21. It is thus understood that, when the collar 124 is supported against the upper face of the frame part 21, the lower end of the well 121 extends below this frame part 21. In this position, the well 121 would thus constitute an obstacle to the sliding of the frame part 21 on the upper face of the dashboard 10.

In order to prevent this, the resiliently deformable part 130 is designed to raise the well 121 into a standby position illustrated in FIG. 6 and FIG. 7, in which the lower end of the well 121 does not extend below the frame part 21.

It will be noted in this case that it has been chosen to raise the collar, and not to produce it with a greater thickness, such that, once the screw has been screwed into the dashboard 10, its head does not project, or projects only slightly, above the surface thereof. In fact, excessive projection would be unsightly, and would be a potential source of injury for a pedestrian who, having collided with the car, would hit the windshield and the dashboard.

In the embodiment illustrated in FIG. 3, and in the variant illustrated in FIG. 4 to FIG. 6, the resiliently deformable part 130 (which, it will be remembered, is used to carry out this raising) comprises a plurality of arms 131, which each comprise a first end secured on the well 121, and a free end situated at a height different from that of the first end (along the main axis A1).

As shown clearly by FIG. 4, in this case the resiliently deformable part 130 comprises exactly three arms 131, the first ends of which are attached to the peripheral edge of the collar 124.

In this case, the first end of each arm 131 is curved in a right angle in order to be attached to the collar. By this means, the remainder of each arm 131 extends substantially ortho-radially relative to the main axis A1 (i.e. on a plane which is perpendicular to the plane containing this axis, and passing via the first end of the arm).

Each arm 131 is also naturally curved downwards, in this case in the form of an “S”. “Naturally” means that at rest, when no force is being applied to the arm, the arm has this form of an “S”. Thus, the free end of each arm 131 can be supported against the upper face of the frame part 21.

As shown clearly by FIG. 7, during the definitive screwing of the screw 31 into one of the tapped bores 17 of the dashboard 10, this screw 31 descends naturally into the well 121 until it cooperates with the tapped bore 17. Once its thread engages with the tapping of this bore, the screw 31 continues to descend until its head is supported against the upper face of the collar 124 (see FIG. 8). During this descent, the screwing of the screw 31 makes it possible to force the arms 131 to be deformed as far as a position in which the lower face of the collar 124 is supported against the frame part 21.

It is understood that, during this screwing operation, the well 121 is subjected to torque around the main axis A1. Means are thus provided for blocking the well 121 so that it does not rotate in the opening 25 of the frame part 21. These means can have different forms

In the embodiment of FIG. 3, and in most of the variants represented, the well 121 has protruding from its outer face an outer rib 123 which extends radially on a plane containing the main axis A1. This outer rib 123 is attached not only to the well 121 but also to the collar 124, which makes it more rigid. It is designed to be accommodated in a notch provided in the edge of the opening 25 of the frame part 21, and to be supported against an edge of this notch during the screwing of the screw 31. It will be noted that this notch has dimensions larger than that of the outer rib 123, such as to leave the desired gap between the well 121 and the edge of the opening 25.

In the variant illustrated in FIG. 13 and FIG. 14, the means for blocking the well 121 so that it does not rotate are in the form of a stop 128. This stop 128 is a small wall which extends protruding above the collar 124 in a position such that, when the screw 31 is screwed, and the well 121 begins to rotate around its main axis A1, this stop 128 is supported against the resiliently deformable connection lug 140, which blocks the rotation of the well 121.

FIG. 3 and FIG. 4 represent in detail the means 110 for securing the pre-mounting system 100 on the frame part 21. In particular, they represent its snapping-on unit 111 in detail.

In this case, this securing means 110 comprises a support 112 formed by a square frontal wall which is bordered at the bottom by a lateral rigidification wall. The resiliently deformable connection lug(s) 140 (which connect(s) this securing means 110 to each well 121) is/are in this case attached to this lateral wall.

The snapping-on unit 111 for its part comprises two identical snapping-on lugs positioned back-to-back. Each lug comprises a flexible strip which extends from the lower face of the frontal wall of the support 112, downwards. At rest, the flexible strips extend such as to be spaced slightly from one another. At its free end, on its face facing opposite the other snapping-on lug, each strip comprises a locking tooth. This unit can thus lock automatically on the frame part 21, when the pre-mounting part 100 is added on above the opening provided in correspondence in the frame part 21.

It will be noted that, preferably, at rest, the lower face of the lateral wall of the support 112 extends on a plane which is parallel to, and distinct from, the plane of the lower face of the collar 124. These two planes are designed to merge when the screw 31 is fully screwed into its tapped bore 17.

The resiliently deformable connection lug 140 which connects this securing means 110 on the well 121 is formed by a strip which, at rest, is preferably curved in the form of an “S” on a plane orthogonal to the main axis A1. This strip has a transverse cross-section, the height of which (parallel to this axis) is greater than the width, which provides it with the desired flexibility on the plane orthogonal to the main axis A1. By this means, it provides the well 121 with mobility on this plane.

In the embodiment of FIG. 3, two wells 121 are thus provided, situated on both sides of the securing means 110. These two wells are connected to this securing means 110 by two distinct resiliently deformable connection lugs 140, which lock on both sides of the lateral wall of the support 112. Thus, the two wells 121 are rendered integral with one another such as to be movable relative to one another.

Preferably, the pre-mounting system 100 is formed in a single piece by molding of a plastic material such as polyamide 6 (PA6) or polyoxymethylene (POM).

The present invention is in no way limited to the embodiment described and represented in FIG. 1 to FIG. 8, and persons skilled in the art will be able to add to it any variant which is in conformity therewith.

Thus, FIG. 9 to FIG. 12 represent four variant embodiments of the well 121 and of the resiliently deformable part 130, which make it possible to raise the well relative to the frame part 21.

In the variant illustrated in FIG. 9, the well 121 is without a collar, and its three arms 131A extend directly from the outer face of the well 121, radially in relation to the main axis A1. These arms 131A are inclined downwards, by the same angle of between 5 and 45°.

In this case, the arms 131A are formed by a single conical part which is cut into three arms by two slots and by a cut-out for the passage of the resiliently deformable connection lug 140. Each arm 131A thus has a width which increases from its end which is attached to the well 121 towards its free end.

In the variant illustrated in FIG. 10, the well 121 bears a collar 124 and the three arms 131B extend radially from this collar 124. This variant is distinguished from the previous one mainly in that each arm 131B has a constant width from its end which is attached to the collar 124 towards its free end. These three arms thus extend on a plane which is inclined downwards relative to the plane of the collar 124.

The variant which is illustrated in FIG. 11 is distinguished from the previous one in that the well 121 is without a collar, and each arm 131C has a first part which is attached directly to the well 121, and extends on a plane orthogonal to the main axis A1, which first part is extended by a second part inclined downwards.

In the variant illustrated in FIG. 12, more than three arms 131D are provided. In this case, eight of them are provided, which extend substantially ortho-radially relative to the main axis A1. These arms are identical. They are connected to the collar 124 by a first end which is curved at a right angle. At rest, most of each arm extends on a plane orthogonal to the main axis A1. However, on its lower face, the free end of each arm has a lug, the end of which extends below the lower face of the collar.

Other variants of the invention, not illustrated in the figures, could be envisaged.

By way of example, the pre-mounting system could be used to secure a device other than a heads-up display, for example a cell phone support arm.

1. A pre-mounting system which is designed to pre-mount a securing screw through an opening provided in a frame part of a device to be secured on a structural element of a motor vehicle, the pre-mounting system comprising:
a securing means which is designed to be secured on said frame part;
a retention means which is designed to retain the securing screw along a main axis, and in a pre-mounting position through the opening; and
a deformable part which, at rest, is designed to retain the retention means in a position which is spaced from the frame part along the main axis, and is designed to be compressed in order to bring the retention means into a position closer to the frame part along the main axis, to assist screwing of the securing screw on the structural element.

2. The pre-mounting system as claimed in claim 1, wherein the retention means comprises a well through which the securing screw is designed to be screwed.

3. The pre-mounting system as claimed in claim 2, wherein an end of the well is bordered, on part of its contour at least, by a support wall, from an edge of which said deformable part extends.

4. The pre-mounting system as claimed in claim 3, wherein the well is bordered around all of its contour by the support wall.

5. The pre-mounting system as claimed in claim 3,
wherein the deformable part comprises at least two arms,
wherein each of the at least two arms comprise a first end secured on the support wall, and a free end situated at a height different from the first end, along the main axis, on a side of the well relative to the support wall.

6. The pre-mounting system as claimed in claim 5, wherein each arm extends substantially radially relative to the main axis.

7. The pre-mounting system as claimed in claim 5, wherein each arm extends substantially ortho-radially relative to the main axis.

8. The pre-mounting system as claimed in claim 2, wherein the well has an inner face protruding from which there extend at least three ribs in which a thread of the securing screw is designed to engage.

9. The pre-mounting system as claimed in claim 2, wherein blocking means are provided which are designed to block the well in rotation relative to the frame part.

10. The pre-mounting system as claimed in claim 9, wherein the blocking means comprise at least one rib which protrudes from an outer face of the well.

11. The pre-mounting system as claimed in claim 1, wherein the securing means and the retention means are rendered integral with one another by a resiliently deformable connection lug which is preferably curved on a plane orthogonal to the main axis.

12. The pre-mounting system as claimed in claim 9, wherein the blocking means comprise at least one support stop against which a resiliently deformable connection lug is designed to abut during the screwing of the securing screw.

13. The pre-mounting system as claimed in claim 1, wherein the securing means is designed to clip into an opening provided in said frame part.

14. The pre-mounting system as claimed in claim 1, wherein two means are provided for retention of two securing screws, which are rendered integral with one another such as to be movable relative to one another on a plane orthogonal to the main axis.

15. A heads-up display for a motor vehicle, comprising:
a frame part which has at least one opening and a securing screw which is engaged through the opening and is designed to be screwed into a structural element of the motor vehicle; and
the pre-mounting system as claimed in claim 1,
wherein the securing means of which is secured on said frame part.

16. The heads-up display as claimed in claim 15, wherein the frame part comprises fitting means which are designed to engage in complementary receiving means of the structural element of the motor vehicle, by a sliding movement.

17. A motor vehicle comprising a windshield and a structural element situated below the windshield,
wherein the heads-up display as claimed in claim 15,
wherein said securing screw of which is screwed into said structural element.
